(19) United States
(12) Patent Application Publication
(10) Pub. No.: US 2026/0340559 A1
(43) Pub. Date: Oct. 29, 2026

(54) INTEGRATED GOVERNANCE FOR ARTIFICIAL INTELLIGENCE

(71) Applicant: International Business Machines Corporation, Armonk, NY (US)

(72) Inventors: Ajethaa Arumugam Murugesapandian, Roswell, GA (US); Neera Mathur, Marietta, GA (US); Lee Cox, Lower Norton (GB); Frazer Dixon, Atlanta, GA (US); William Brant Campbell, Smyrna, GA (US); PR Kolwalkar, San Ramon, CA (US); Apurv Ray Johar, Dublin, CA (US); Kimmy de Joode, Madrid (ES); Kristi Spess, Austin, TX (US); John Barcik, Ellijay, GA (US); Carlos Eduardo Salazar Cardenas, Tlalpan (MX); Lisa Michelle Avery, Richmond Hill (CA); Paul Taylor, Redwood City, CA (US)

(21) Appl. No.: 19/245,910

(22) Filed: Jun. 23, 2025

(30) Foreign Application Priority Data
Apr. 23, 2025 (EP) 25382408.0

(51) Int. Cl. G06Q 10/0637; G06N 20/00

(52) U.S. Cl. CPC G06Q 10/06375; G06N 20/00

(57) ABSTRACT

Systems and techniques that facilitate comparisons of machine learning model generated summaries are provided. For example, one or more embodiments described herein can comprise a system, which can comprise a memory that can store computer executable components. The system can also comprise a processor, operably coupled to the memory that can execute the computer executable components stored in memory. The computer executable components can comprise an integrated regulatory compliance component, comprising a machine learning model, wherein the machine learning model: identifies new regulations and enterprise standards for an enterprise; determines an impact to the enterprise based on the new regulations and enterprise standards; and updates baseline enterprise standards with one or more compliance actions based on the impact, wherein the baseline enterprise standards comprise an enterprise protected information baseline and an artificial intelligence (AI) baseline.

### BACKGROUND

The subject disclosure relates to the operation of artificial intelligence systems, and more specifically, to automated and integrated governance for artificial intelligence.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate integrated governance and compliance checks for artificial intelligence systems are provided.

According to an embodiment, a system can comprise: a memory that stores computer executable components; and a processor that executes the computer executable components stored in the memory, wherein the computer executable components comprise: an integrated regulatory compliance component, comprising a machine learning model, wherein the machine learning model: identifies new regulations and enterprise standards for an enterprise; determines an impact to the enterprise based on the new regulations and enterprise standards; and updates baseline enterprise standards with one or more compliance actions based on the impact, wherein the baseline enterprise standards comprise an enterprise protected information baseline and an artificial intelligence (AI) baseline. An advantage of such a system is that it enables automatic updating of the baseline standards, allowing compliance audits and checks across all connected systems in the enterprise in real-time.

In one or more embodiments, the computer executable components can further comprise a factsheet generation component, comprising a second machine learning model that: tracks use of data comprising protected information (e.g., personal information, privacy data), AI systems, AI models, and AI training datasets through one or more information tracking subcomponents; compares the use of the data comprising protected information, AI systems, AI models, and AI training datasets to the updated baseline enterprise standards; and generates, using the second machine learning model, model factsheets for the AI models based on the comparison, wherein the model factsheets comprise information used by the AI models, deployment histories of the AI models, and performance characteristics of the AI models. An advantage of such a system is that the factsheets allow for real time compliance checks of AI models and systems, throughout the enterprise, against the enterprise baselines.

According to another embodiment, a computer-implemented method can comprise identifying, by a device operatively coupled to a processor, using a machine learning model, new regulations and enterprise standards for an enterprise; determining, by the device, using the machine learning model, an impact to the enterprise based on the new regulations and enterprise standards; and updating, by the device, using a machine learning model, baseline enterprise standards with one or more compliance actions based on the impact, wherein the baseline enterprise standards comprise an enterprise baseline and an artificial intelligence (AI) baseline. An advantage of such a computer-implemented method is that it enables automatic updating of the baseline standards, allowing compliance audits and checks across all connected systems in the enterprise in real-time.

In one or more embodiments, the computer-implemented method can further comprise tracking, by the device, using a second machine learning model, use data comprising protected information, AI systems, AI models and AI training data; comparing, by the device, using the second machine learning model, AI systems, AI models, and AI training datasets to the updated baseline enterprise standards; and generating, by the device, using the second machine learning model, model factsheets for the AI models based on the comparison, wherein the model factsheets comprise information used by the AI models, deployment histories of the AI models, and performance characteristics of the AI models. An advantage of such a computer-implemented method is that the factsheets allow for real time compliance checks of AI models and systems, throughout the enterprise, against the enterprise baselines.

According to another embodiment, a computer program product can comprise a computer readable storage medium having program instructions embodied therewith, the program instructions executable by a processor to cause the processor to identify, by the processor, using a machine learning model, new regulations and enterprise standards for an enterprise; determine, by the processor, using the machine learning model, an impact to the enterprise based on the new regulations and enterprise standards; and update, by the processor, using a machine learning model, baseline enterprise standards with one or more compliance actions based on the impact, wherein the baseline enterprise standards comprise an enterprise baseline and an artificial intelligence (AI) baseline. An advantage of such a computer program product is that it enables automatic updating of the baseline standards, allowing compliance audits and checks across all connected systems in the enterprise in real-time.

In one or more embodiments, the program instructions can further cause the processor to track, by the processor, using a second machine learning model, use data comprising protected information, AI systems, AI models and AI training data; compare, by the processor, using the second machine learning model, AI systems, AI models, and AI training datasets to the updated baseline enterprise standards; and generate, by the processor, using the second machine learning model, model factsheets for the AI models based on the comparison, wherein the model factsheets comprise information used by the AI models, deployment histories of the AI models, and performance characteristics of the AI models. An advantage of such a computer program product is that the factsheets allow for real time compliance checks of AI models and systems, throughout the enterprise, against the enterprise baselines.

### DESCRIPTION OF THE DRAWINGS

FIGS. 1, 2 and 3 illustrate block diagrams of example, non-limiting, systems that can facilitate automated and integrated governance in accordance with one or more embodiments described herein.

FIG. 4 illustrates an example of a flow diagram of the generation of enterprise baseline standards in accordance with one or more embodiments described herein.

FIG. 5 illustrates a flow diagram of the collection of information for factsheet generation in accordance with one or more embodiments described herein.

FIG. 6 illustrates a flow diagram of factsheet generation in accordance with one or more embodiments described herein.

FIG. 7 illustrates an example of a non-limiting factsheet in accordance with one or more embodiments described herein.

FIG. 8 illustrates a flow diagram of an example, non-limiting, computer-implemented method that facilitates automatic updates of enterprise compliance standards in accordance with one or more embodiments described herein.

FIG. 9 illustrates a flow diagram of an example, non-limiting, computer-implemented method that facilitates automatic generation of model factsheets in accordance with one or more embodiments described herein.

FIG. 10 illustrates an example, non-limiting environment for the execution of at least some of the computer code in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As referenced herein, an “entity” can comprise a client, a user, a computing device, a software application, an agent, a machine learning (ML) model, an artificial intelligence (AI) model, and/or another entity.

As artificial intelligence (AI) grows both in capability and usage, there has been a similar growth in regulation on the use of AI, both in terms of use case, and the data used to train and fine tune such AI models and systems. Similarly, there has been a growth in regulations related to data protection and the collection and use of certain types of data, both within and without AI systems. These regulations can be both governmental (e.g., legal requirements promulgated by an international, national, territorial, or local authority) or those promulgated by an enterprise or organization for internal use within the enterprise or organization. Accordingly, large enterprises operating within multiple jurisdictions can face a myriad of complex and changing regulations and compliance obligations related to AI usage and deployment, as well as data protection, resulting in difficulties ensuring compliance.

In view of the problems discussed above, the present disclosure can be implemented to produce a solution to one or more of these problems by identifying, using a first machine learning model, new regulations and enterprise standards for an enterprise, determining, using the first machine learning model, an impact to the enterprise based on the new regulations and enterprise standards, and updating, using the first machine learning model, baseline enterprise standards with one or more compliance actions based on the impact, wherein the baseline standards comprise an enterprise protected information baseline and an artificial intelligence (AI) baseline. The AI baseline can comprise compliance standards or obligations related to the use case of, training data utilized, jurisdiction deployed or utilized in, or another characteristic related to the training and deployment of AI models or systems. The protected information baseline can comprise definitions related to what types of information are to be regarded as private or protected, how this information can be utilized or disclosed, how the information should be stored or protected, and any other compliance standards or obligations related to data protection. These enterprise baselines can be utilized as a generalized, all-encompassing baseline for compliance across the enterprise, regardless of the specific AI system, deployment region, or information utilized within the AI system. Accordingly, these enterprise baseline standards can be deployed across an enterprise, easing the burden of compliance auditing across the enterprise by eliminating the use of a myriad of compliance standards for each separate jurisdiction.

In various embodiments, the solution to the above-described problems can further comprise tracking, using a second machine learning model, use of data comprising protected information, AI systems information, AI model information and AI training datasets through one or more subcomponents, comparing, using the second machine learning model, the use of the data comprising protected information, AI systems, AI models, and AI training datasets to the updated baseline enterprise standards, and generating, using the second machine learning model, model factsheets based on the comparison, wherein the model factsheets comprise information used by the AI models and AI systems, deployment histories of the AI models and AI systems, and performance characteristics of the AI models and AI systems. In one or more embodiments, data protection factsheets can also be generated, wherein the data protection factsheets comprise information related to use, collection, and storage of private or protected data. These factsheets can be automatically updated in real time, allowing access to up-to-date information regarding AI and data protection regulation compliance across the enterprise's network, thereby enabling automated and constant compliance auditing.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

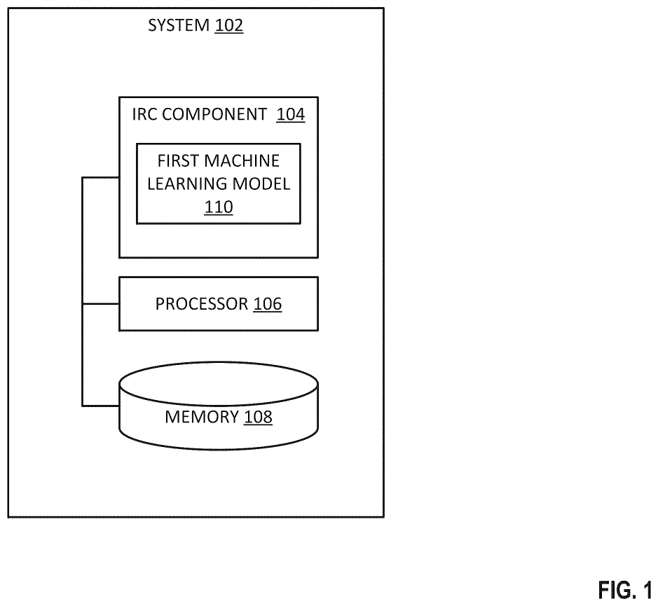

FIGS. 1, 2 and 3 illustrate block diagrams of example, non-limiting systems 102, 202 and 302 that can facilitate integrated AI system and protected data governance in accordance with one or more embodiments described herein. Aspects of systems (e.g., systems 102, 202, 302 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines, (e.g., computers, computing devices, virtual machines, etc.) can cause the machines to perform the operations described. System 102 can comprise integrated regulatory compliance component (IRC) 104, first machine learning model 110, processor 106 and memory 108. System 202 can further comprise factsheet generation component 204 and second machine learning model 206. In system 302, factsheet generation component 204 can further comprise AI governance subcomponent 308, initiative manager subcomponent 310, data governance subcomponent 312, protected information governance subcomponent 316 and entity manager subcomponent 314.

In various embodiments, systems 102, 202 and 302 can comprise a processor 106 (e.g., a computer processing unit, microprocessor) and a computer-readable memory 108 that is operably connected to the processor 106. The memory 108 can store computer-executable instructions which, upon execution by the processor, can cause the processor 106 and/or other components of the systems 102 and 202 (e.g., IRC component 104, first machine learning model 110, factsheet generation component 204, second machine learning model 206, AI governance subcomponent 308, initiative manager subcomponent 310, data governance subcomponent 312 protected information governance subcomponent 316 and entity manager subcomponent 314) to perform one or more acts. In various embodiments, memory 108 can store computer-executable components (e.g., IRC component 104, first machine learning model 110, factsheet generation component 204, second machine learning model 206, AI governance subcomponent 308, initiative manager subcomponent 310, data governance subcomponent 312 protected information governance subcomponent 316 and entity manager subcomponent 314) and processor 106 can execute the computer-executable components.

According to some embodiments, first machine learning model 110 and second machine learning model 206 can employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, first machine learning model 110 and second machine learning model 206 can employ principles of probabilistic and decision theoretic inference to determine one or more responses based on information retained in a knowledge source database. Additionally, or alternatively first machine learning model 110 and second machine learning model 206 can rely on predictive models constructed using machine learning and/or automated learning procedures. Logic-centric inference can also be employed separately or in conjunction with probabilistic methods. For example, decision tree learning can be utilized to map observations about data retained in a knowledge source database to derive a conclusion as to a response to a question.

As used herein, the term “inference” refers generally to the process of reasoning about or inferring states of the system, a component, a module, the environment, and/or assessments from one or more observations captured through events, reports, data, and/or through other forms of communication. Inference can be employed to identify a specific context or action, or can generate a probability distribution over states, for example. The inference can be probabilistic. For example, computation of a probability distribution over states of interest can be based on a consideration of data and/or events. The inference can also refer to techniques employed for composing higher-level events from one or more events and/or data. Such inference can result in the construction of new events and/or actions from one or more observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects. Furthermore, the inference processes can be based on stochastic or deterministic methods, such as random sampling, Monte Carlo Tree Search, and so on.

The various aspects can employ various artificial intelligence-based schemes for carrying out various aspects thereof. For example, a process for updating enterprise base line standards and factsheet generation, which can be enabled through an automatic classifier system and process.

A classifier is a function that maps an input attribute vector, x=(x1, x2, x3, x4, xn), to a confidence that the input belongs to a class. In other words, f(x)=confidence(class). Such classification can employ a probabilistic and/or statistical-based analysis (e.g., factoring into the analysis utilities and costs) to prognose or infer an action that should be employed to make a determination. The determination can include, but is not limited to, the impact a regulation will have on an enterprise, whether to update an enterprise baseline standard based on the impact, generation of model fact sheet, and the like.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing and recording target entity behavior, by receiving extrinsic information, and so on). For example, SVM's can be configured through a learning phase or a training phase within a classifier constructor and feature selection module. Thus, a classifier(s) can be used to automatically learn and perform a number of functions, including but not limited to, determining the impact a regulation will have on an enterprise, whether to update an enterprise baseline standard based on the impact, generation of model fact sheet, and the like. Furthermore, one or more aspects can employ machine learning models that are trained utilizing reinforcement learning. For example, penalty/reward scores can be assigned for various outputs generated by first machine learning model 110 and second machine learning model 206 based on defined entity preferences. Accordingly, first machine learning model 110 and second machine learning model 206 can learn via selecting options with lower penalties and/or higher rewards in order to reduce an overall penalty score and/or increase an overall reward score.

In one or more embodiments, IRC component 104 can identify new regulations and enterprise standards for an enterprise. For example, IRC component 104 can receive as input new regulations related to the use and training of AI systems and data protection information promulgated by one or more governmental authorities. In some embodiments, these regulations can be limited to those that affect regions in which the enterprise has a presence. In some embodiments, these regulations can be related to any region, including those that the enterprise lacks a presence in, to enable better proactive compliance if the enterprise begins operations within such regions. The enterprise standards can comprise regulations internal to the enterprise (e.g., those that do not have a legal requirement, but which the enterprise itself wishes to operate by). In one or more embodiments, such regulations and standards can be input directly into IRC component 104. In one or more alternative embodiments, IRC component 104 can scrape one or more information sources, such as the internet or internal enterprise documentation to gather the new regulations and standards.

In one or more embodiments, IRC component 104 can determine, using first machine learning model 110, an impact to the enterprise based on the new regulations and enterprise standards. For example, first machine learning model 110 can scrape the new regulations and enterprise standards for new compliance obligations/actions, prohibitions on specific AI use cases, prohibitions on specific use of protected information, newly defined forms of protected data, storage and protection actions for protected data, reporting or auditing procedures, and/or other compliance related actions. Once the compliance obligations/actions of the new regulations or standards have been identified, first machine learning model 110 can determine an impact to the enterprise by comparing the newly identified compliance obligations/actions to the enterprise baseline standards. The enterprise baseline standards can comprise compliance obligations/actions and/or auditing procedures that are to be applied across the entire enterprise, regardless of jurisdiction or territory. The enterprise baseline standards can comprise an AI baseline standard comprising compliance obligations/actions related to the use, development, deployment and training of AI systems, AI models, or applications utilizing AI models or systems. The enterprise baseline standards can further comprise a protected information baseline comprising compliance obligations/actions related to what constitutes private data, how that private data can be utilized, and protections and storage standards for such private data.

When comparing the newly identified compliance obligations/actions to the existing enterprise baseline standards, first machine learning model 110 can determine if the newly identified compliance obligations already exist within the baseline standards. For example, the new regulations may relate to a jurisdiction adopting the same or similar compliance obligations of another jurisdiction that are already within the enterprise baselines. Accordingly, the impact of the new regulations is relatively low, and the enterprise baselines do not call for updating. Alternatively, if the enterprise baselines lack obligations similar to the newly identified compliance obligations, then first machine learning model 110 can determine the impact is high, and the baseline enterprise standards can be updated. In another example, if the newly identified compliance obligations are related to a standard for a jurisdiction in which the enterprise does not operate, the first machine learning model 110 can determine the impact is low, whereas standards for jurisdictions in which the enterprise operates can be assigned a high impact. In one or more embodiments, the impact can be assigned a numerical score within a defined range to better represent impact.

Once the impact of new regulations or standards is determined, first machine learning model 110 can update the enterprise baseline standards accordingly. For example, for new regulations with high impacts, first machine learning model 110 can update one or more of the enterprise baseline standards with the newly identified compliance obligations/actions. If the new regulations are related only to AI, then the AI baseline standard can be updated. If the new regulations are related only to data protection, then the protected information baseline standard can be updated. In some cases, regulations related to the use of protected data or information as input or training data for AI, both the AI baseline and protected information baseline standards can be updated. It should be appreciated that in one or more embodiments, the enterprise baseline standards can comprise additional baseline standards beyond those related to AI and data protection.

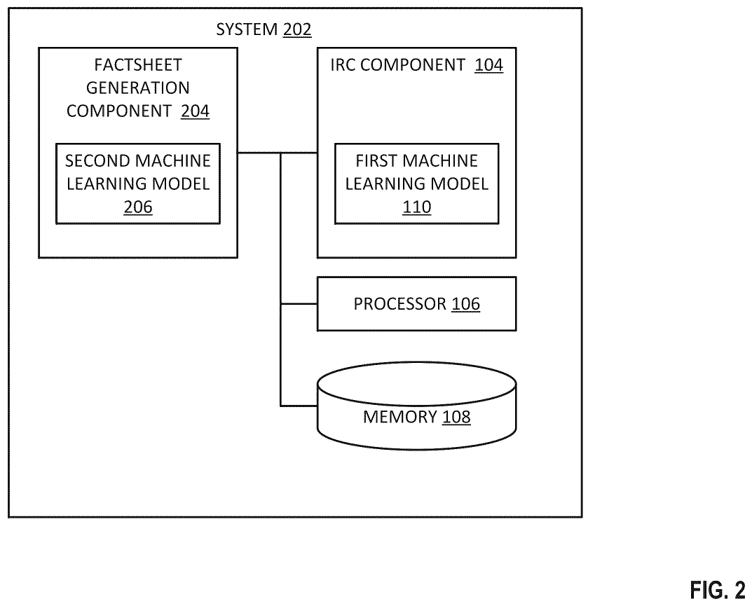

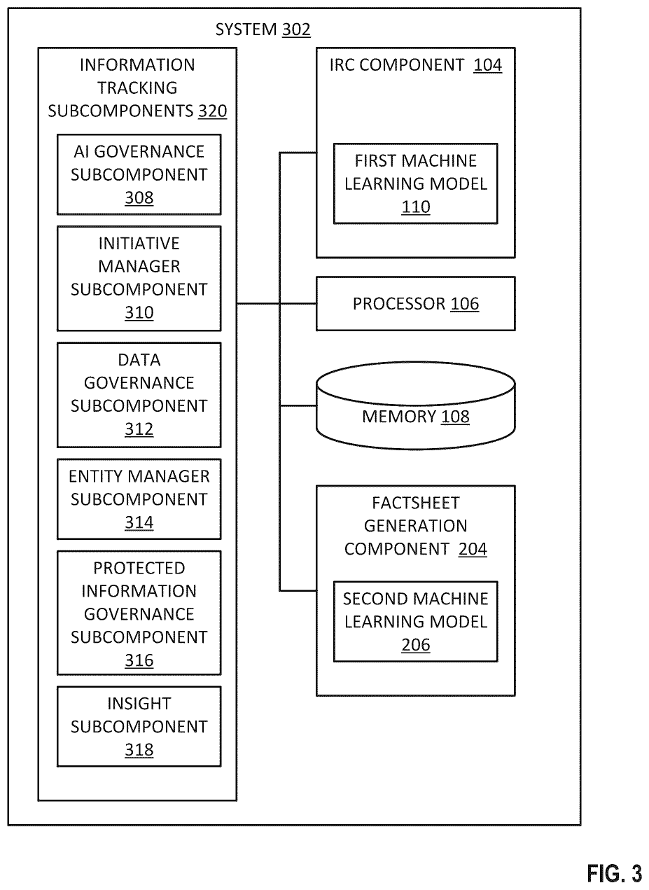

Continuing to FIG. 2, in one or more embodiments, factsheet generation component 204 can track the use of data comprising protected information (e.g., data such as personal information and protected data), AI systems, AI models and AI training components through one or more subcomponents. For example, factsheet generation component 204 can catalog information related to the use and location of protected information, the development, deployment, deployment regions, training datasets and use cases of AI systems and the AI models within those systems, within the entire enterprise. In one or more embodiments, this information can be manually input to factsheet generation component 204, or factsheet generation component 204 can automatically search and scrape enterprise documentation to automatically gather relevant information. In various embodiments this data can be portioned and cataloged by different information tracking subcomponents 320 (described in greater detail below in relation to FIG. 3), wherein the different subcomponents can generate assessments based on the use of such data. In one or more embodiments, factsheet generation component 204 can receive one or more manual inputs or automated intake of records related to a compliance framework, wherein the records comprise at least one of applications storing protected information, AI systems, AI models, and AI training datasets, and wherein the receiving the one or more manual inputs and automated intake of records further comprises assessing an applicability of a record to one or more of the baseline enterprise standards.

Second machine learning model 206 can then compare the assessments to the updated enterprise baseline standards and utilize the comparison to generate model and protected information factsheets based on the comparison. For example, for each AI model or AI system, second machine learning model 206 can generate a factsheet comprising information describing if the use of the AI model or AI system complies with the enterprise baseline standards, as well as information related to the deployment regions, use history and development history of the AI models or AI systems. In the event that some portion of a specific AI system or AI model is not in compliance with the enterprise baseline standards, the factsheet can identify which enterprise baseline standard is violated (e.g., the AI baseline standard and/or the protected information baseline standard), what portion of the relevant baseline standard was violated, what regulations and enterprise standards were violated, when they were violated and/or remedial actions. In one or more embodiments, factsheet generation component 204 can automatically notify one or more entities in the enterprise of the non-compliance, as well as automatically transmitting the factsheet to the one or more entities. In various embodiments, factsheet generation component 204 can similarly generate factsheets for types of specific databases of protected information and for specific AI training datasets or categories of AI training datasets.

Turning to FIG. 3, in one or more embodiments, information tracking subcomponents 320 can comprise AI governance subcomponent 308, initiative manager subcomponent 310, data governance subcomponent 312, entity manager subcomponent 314, protected information governance subcomponent 316 and insight subcomponent 318 that can assist factsheet generation component 204 with the tracking and cataloging of relevant data for factsheet generation.

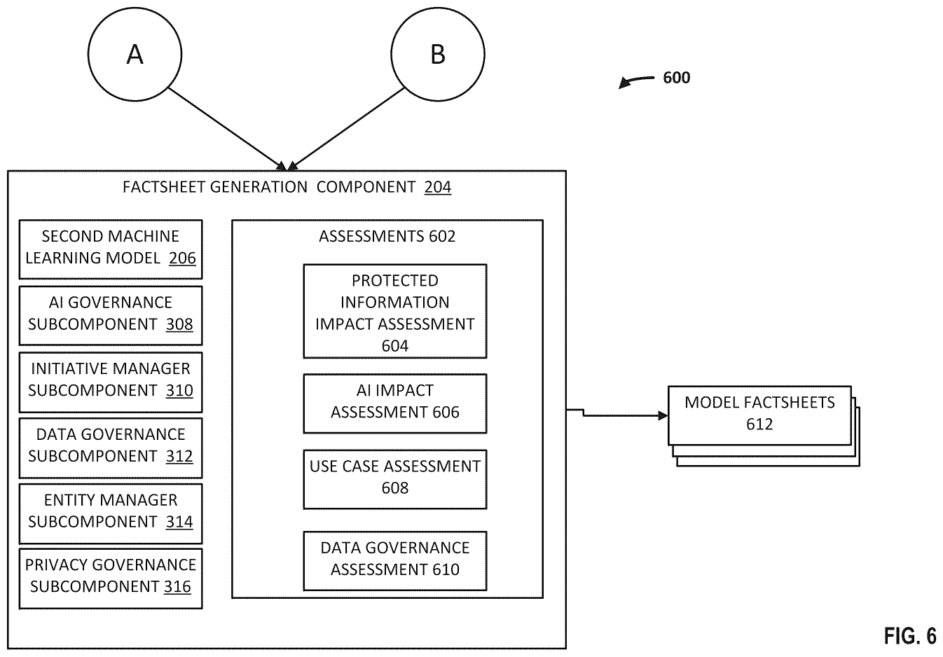

In one or more embodiments, AI governance subcomponent 308 can catalog AI systems, AI models and AI applications identified in the data received by factsheet generation component 204 and determines when a new AI record is called for. For example, when a new AI model, AI system or AI application is introduced into the data collected by factsheet generation component 204, AI governance subcomponent 308 can create a new record for the new AI model, AI system or AI application. AI governance subcomponent 308 can furthermore update existing records when new data is received. For example, if an existing AI model is utilized for a new use case, the record corresponding to said AI model is updated accordingly. As part of the update process, AI governance subcomponent 308 can track one or more applications within the enterprise identified as having an AI component, such as an AI system or AI model, to ensure that records are automatically updated. Furthermore, AI governance subcomponent 308 can generate AI impact assessments and use case assessments (such as AI impact assessment 606 and use case assessment 608 of FIG. 6) that comprise a series of questions and answers related to the use and deployment of the various AI systems, AI models and AI applications within the enterprise. As discussed above in relation to second machine learning model 206, the assessments can be utilized as part of the factsheet generation process.

In one or more embodiments, protected information governance subcomponent 316 can catalog the use of protected information within the enterprise and determine when a new protected information record is called for. For example, when a new source or type of protected data is identified, either when new data is collected or when the definition of what constitutes protected data or protected information is expanded by updated baseline standards, protected information governance subcomponent 316 can create a new record for the source, storage location, and/or type of protected information. Protected information governance subcomponent 316 can furthermore update exiting records when new data is received. For example, if existing protected information is moved to a new storage location or given updated cybersecurity protection, protected information governance subcomponent 316 can update the record. As part of the update process, protected information governance subcomponent 316 can track the usage of protected information within the enterprise to ensure that records are automatically updated. Furthermore, protected information governance subcomponent 316 can generate protected information impact assessments (such as protected information impact assessment 604 of FIG. 6) that comprise a series of questions and answers related to the use, collection and storage of the various protected information within the enterprise. As discussed above in relation to second machine learning model 206, the assessments can be utilized as part of the factsheet generation process.

In one or more embodiments, initiative manager subcomponent 310 can identify one or more components of the enterprise impacted by one or more new regulation or organization standards. For example, one or more entities within the enterprise can establish a new compliance initiative, wherein the initiative can comprise updating enterprise standards or re-evaluating regulations related to specific protected data types, protected data locations, portions of the enterprise, specific AI models, specific AI systems, or other subcomponents of the enterprise. When a new initiative is started, initiative manager subcomponent 310 can identify one or more components, portions or departments within the entire that will be impacted by the initiative and automatically notify those identified of the initiative and the new standards or actions of the initiative, thereby enabling enterprise-wide compliance of the initiative.

In one or more embodiments, data governance subcomponent 312 can track design connections between one or more AI models, AI systems and/or AI applications within the enterprise. For example, AI models are often developed iteratively or adapted from AI models originally utilized for different use cases or trained with different training datasets. Accordingly, data governance subcomponent 312 can track the developmental and shared history of various AI models, AI systems and AI applications to ensure that information relevant to compliance with the baseline standards is retained as AI models are iterated upon, adapted for different uses, or deployed by different departments or entities within the organization. Furthermore, data governance subcomponent 312 can further track approval of one or more datasets used for training or as input for one or more AI models, AI systems, or AI applications. For example, entities within the organization can approve specific datasets for use with AI models (e.g., as inputs for deployment or as training or finetuning data) based on criteria in the baseline standards, such as deployment jurisdiction of the AI model, use case of the AI model and/or the nature of the dataset. For example, the use of some types of protected information may be prohibited for use with AI in specific regions or jurisdictions. Accordingly, data governance subcomponent 312 can track approval and prohibitions of specific datasets for use within regions. In another example, the use of some types of data may be prohibited for specific use cases of AI models. Accordingly, data governance subcomponent 312 can track the approval and prohibitions of the types of data and specific datasets for various use cases. Furthermore, data governance subcomponent 312 can generate data governance assessments (such as data governance assessment 610 of FIG. 6) that comprise a series of questions and answers related to the connections between AI models and the approval of use of types of datasets or specific datasets within the organization. As discussed above in relation to second machine learning model 206, the assessments can be utilized as part of the factsheet generation process.

In one or more embodiments, entity manager subcomponent 314 can catalog systems and/or departments within the enterprise that store protected information and AI models, AI system, and/or AI applications. Accordingly, factsheet generation component 204, and the various other subcomponents thereof, can utilize the catalog of entity manager subcomponent 314 as part of their operations.

In one or more embodiments, insight subcomponent 318 can generate one or more insights from the tracked data. In one or more embodiments, these insights can comprise identifications of use trends of AI systems, AI models, AI training datasets, and protected information. For example, insight subcomponent 318 can identify a use trend wherein multiple AI models or AI systems are being utilized for the same or similar purposes across the enterprise. In another example, insight subcomponent 318 can identify a trend of a specific type of protected data being incorrectly stored or utilized across the enterprise or a portion of the enterprise. In various embodiments, these insights can be identified based on comparing meta data tags assigned to AI systems, AI models, AI training datasets, and protected information. In another embodiment, insight subcomponent 320 can comprise a third machine learning model that identifies insights from the tracked data. Alternatively, in one or more embodiments, insight subcomponent 320 can utilize second machine learning model 206 of factsheet generation component 204 to identify insights from the tracked data. In one or more embodiments, insight subcomponent 318 can automatically notify one or more entities within the enterprise with the insights, thereby enabling more proactive compliance management and action.

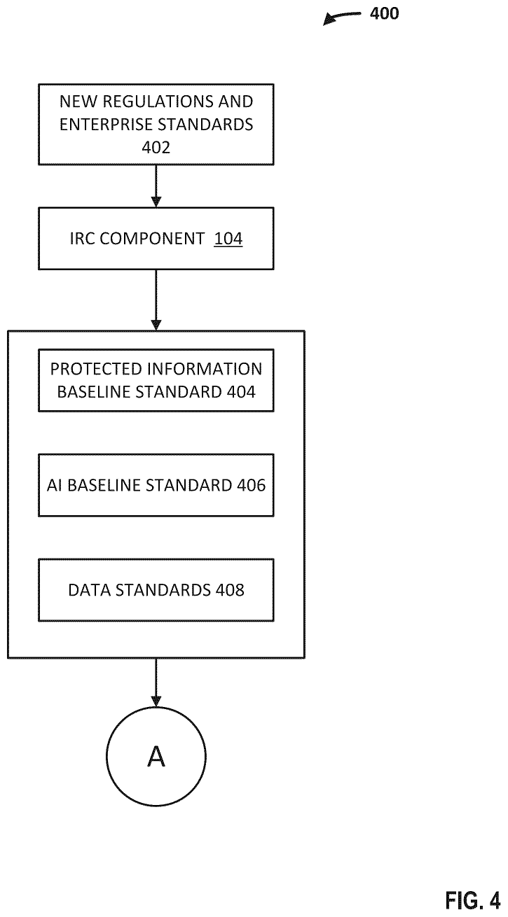

FIG. 4 illustrates an example of a flow diagram 400 of the generation of enterprise baseline standards in accordance with one or more embodiments described herein.

As shown, IRC component 104 can receive new regulations and enterprise standards 402, as input. As described above in relation to FIG. 1, the new regulations and standards can be manually collected and input, or alternatively, IRC component 104 can automatically collect new regulations and standards through collection methods such as scraping information from regulatory authorities or enterprise databases. IRC component 104 can then determine the impacts of the new standards and regulations to the enterprise and update one or more enterprise baseline standards based on the determined impact. For example, as described above in relation to FIG. 1, the enterprise baseline standards can comprise a protected information baseline standard 404 related to the collection, storage and use of information considered private, privileged or protected. Additionally, as described above in relation to FIG. 1, the enterprise baseline standards can further comprise an AI baseline standard 406 related to the development, training, deployment and use cases of AI models, AI system, and/or AI applications. In one or more additional embodiments, the baseline standards can further comprise data standards 408. The data standards 408 can relate to the collection, storage and use of data generally, and/or to specific types of data that may not qualify as protected information but still have one or more specific compliance standards or regulations related to said specific types of data. Furthermore, the entirety of the enterprise baseline standards, represented as A, can be utilized as input for factsheet generation component 204 as illustrated in FIG. 6.

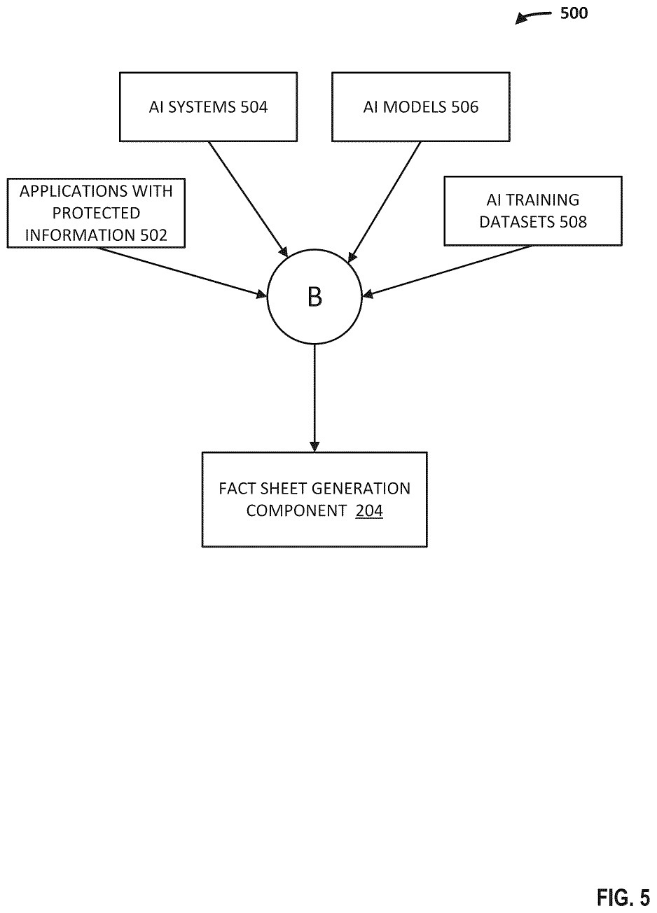

FIG. 5 illustrates a flow diagram 500 of the collection of information for factsheet generation in accordance with one or more embodiments described herein.

As described above in relation to FIG. 2, factsheet generation component 204 can receive both manual inputs and automatically intake records related to an overall compliance framework. As shown in FIG. 5, these inputs, collectively shown as B, can comprise information from the enterprise such as applications or systems with protected information 502, data related to AI systems 504, data related to AI models 506, AI training datasets 508, or other information that is related to ensuring the compliant use of AI and protected information.

FIG. 6 illustrates a flow diagram 600 of factsheet generation in accordance with one or more embodiments described herein.

As described above in relation to FIGS. 2 and 3, factsheet generation component 204 can receive the enterprise baseline standards, shown as A, and the records related to the compliance framework, illustrated as B. Factsheet generation component 204 can sort these inputs for relevancy and assign them to one or more of the various subcomponents of factsheet generation component 204. The various subcomponents can then catalog the input data B, as well as generate the assessments 602. Second machine learning model 206 can then utilize the enterprise baseline standards, the input information and the assessments 602 to generate one or more model factsheets 612.

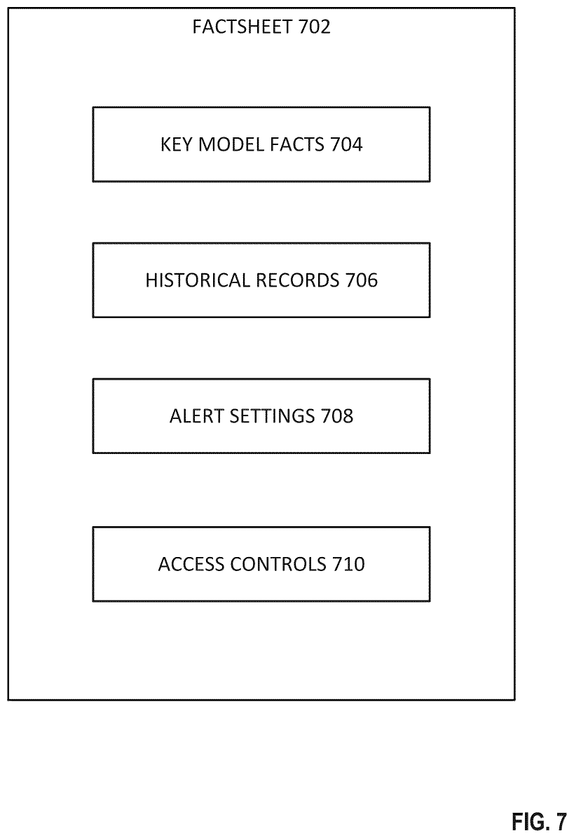

FIG. 7 illustrates an example of a non-limiting factsheet 702 in accordance with one or more embodiments described herein.

As described above in relation to FIGS. 1-3, factsheet generation component 204 can generate example factsheet 702. In one or more embodiments, factsheet 702 can be directed to a specific AI system, AI model or AI application within the enterprise. As shown, factsheet 702 can comprise key model facts 704, historical records 706, alert settings 708 and access controls 710. For example, key model facts 704 can comprise information such as the name and version number of the AI model, what departments within the enterprise use the AI model, the use case or use cases of the AI model, what territories or jurisdictions the AI model is used in, the types of datasets being used in conjunction with the AI model, or other information related to the current use of the AI model. Historical records 706 can comprise information such as the development and version history of the AI model, related AI models, past use cases, departments within the enterprise that previously used the AI model and the related time frame, jurisdictions the AI model was previously deployed in and the related timeframe, previous used cases and the related timeframe, past audits or other historical data related to past use and development of the AI model. Alert settings 708 can comprise conditions that will trigger an alert, and to what entity that alert should be sent. Accordingly, if an event condition, such as non-compliance with the baseline standards, is triggered, factsheet generation component 204 can automatically send an alert to one or more listed entities within the enterprise, thereby preventing the chance of continued or long-term non-compliance. Access controls 710 can comprise information regarding what entities within the organization are permitted to view or possibly modify factsheet 702 to help protect any potential protected information that may be stored in factsheet 702.

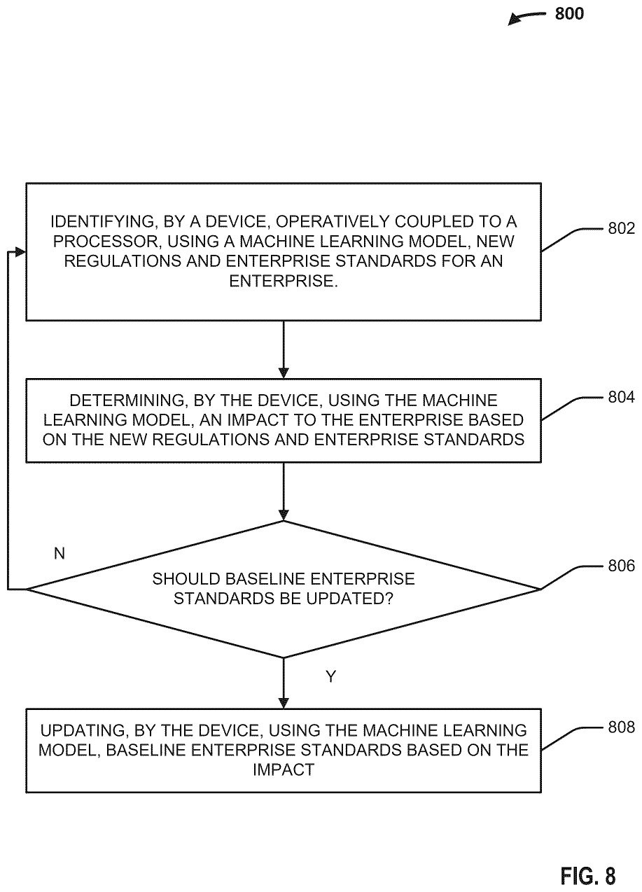

FIG. 8 illustrates a flow diagram of an example, non-limiting, computer-implemented method 800 that facilitates automatic updates of enterprise compliance standards in accordance with one or more embodiments described herein.

At 802, method 800 can comprise identifying, by the device (e.g., system 102 and/or IRC component 104), operatively coupled to a processor, using a machine learning model (e.g., first machine learning model 110) new regulations and enterprise standards for an enterprise. For example, as described above in relation to FIGS. 1-6, IRC component 104 can receive as input documentation of new compliance regulations or enterprise standards. Furthermore, in one or more embodiments, IRC component 104 can scrape or search one or more information sources, such as the internet or a database for new regulations or enterprise standards.

At 804, method 800 can comprise determining, by the device (e.g., system 102 and/or IRC component 104), the impact to the enterprise based on the new regulations and enterprise standards. For example, if the new regulations relate to a territory or jurisdiction wherein the enterprise is not active, then the new regulations will have a low impact. Alternatively, if the new regulations carry a heavy penalty for non-compliance, then a high impact can be assigned.

At 806, method 800 can comprise determining, by the device, (e.g., system 102, and/or IRC component 104), if the enterprise baseline standards should be updated. For example, if the impact is high, or the compliance actions within the new regulations are absent from the enterprise baseline standards, IRC component 104 can determine that the standards should be updated. If the impact is low, or the compliance actions within the new regulations are already present in the enterprise baseline standards, IRC component 104 can determine that the standards should be updated. In response to a NO determination, method 800 can return to step 802 and continue identifying new regulations and enterprise standards. In response to a YES determination, method 800 can proceed to step 808.

At 808, method 800 can comprise updating, by the device, (e.g., system 102, and/or IRC component 104), the baseline enterprise standards based on the impact. For example, as described above in relation to FIGS. 1-6, the enterprise baseline standards can be updated with one or more compliance actions from the new regulations or enterprise standards.

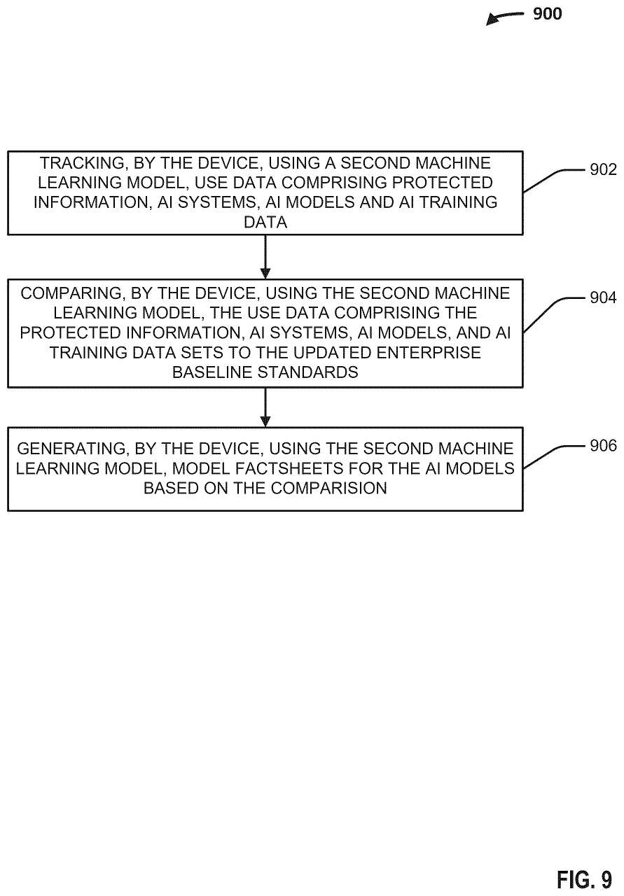

FIG. 9 illustrates a flow diagram of an example, non-limiting, computer-implemented method 900 that facilitates automatic generation of model factsheets in accordance with one or more embodiments described herein.

At 902, method 900 can comprise tracking, by a device (e.g., system 102 and/or factsheet generation component 204), operatively coupled to a processor, using a machine learning model (e.g., second machine learning model 206), use data comprising protected information, AI systems, AI models and AI training data. For example, as described above in relation to FIGS. 1-6, factsheet generation component 204 can track how and where various protected information, AI systems, AI models and AI training data are being stored and how they are being stored and utilized through information tracking subcomponents 320.

At 904, method 900 can comprise comparing, by the device (e.g., system 102 and/or factsheet generation component 204), the use data to the updated enterprise baseline standards. For example, as described above in relation to FIGS. 1-6, factsheet generation component 204 can compare the use data to the updated enterprise baseline standards to determine if the use data is consistent with the compliance actions within the enterprise baseline standards.

At 906, method 900 can comprise generating, by the device (e.g., system 102 and/or factsheet generation component 204), model factsheets for the AI models and AI systems based on the comparison. For example, as described above in relation to FIGS. 1-6, for each AI model or AI system, second machine learning model 206 can generate a factsheet comprising information describing if the use of the AI model or AI system complies with the enterprise baseline standards, as well as information related to the deployment regions, use history and development history of the AI models or AI systems.

A practical application of system 102 is the ability to perform auditing in real-time across a host of applications, jurisdictions and data storage centers. For example, through the use of the factsheet generation and automatic notification when a factsheet shows non-compliance allows for faster reaction time on remedial actions than would otherwise be possible.

It is to be appreciated that systems 102, 202 and 302 can utilize various combination of electrical components, mechanical components, and circuity that cannot be replicated in the mind of a human or performed by a human as the various operations that can be executed by systems 102, 202, 302 and/or components thereof as described herein are operations that are greater than the capability of a human mind. For instance, the amount of data processed, the speed of processing such data, or the types of data processed by systems 102, 202, 302 over a certain period of time can be greater, faster, or different than the amount, speed, or data type that can be processed by a human mind over the same period of time. For example, a single human mind or even multiple human minds cannot track in real time, all storage locations and use of an AI model within all networks of an enterprise. According to several embodiments, systems 102, 202 and 302 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that systems 102, 202 and 302 can include information that is impossible to obtain manually by an entity, such as a human user. For example, the type, amount, and/or variety of information included in systems 102, 202 and 302 can be more complex than information obtained manually by an entity, such as a human user.

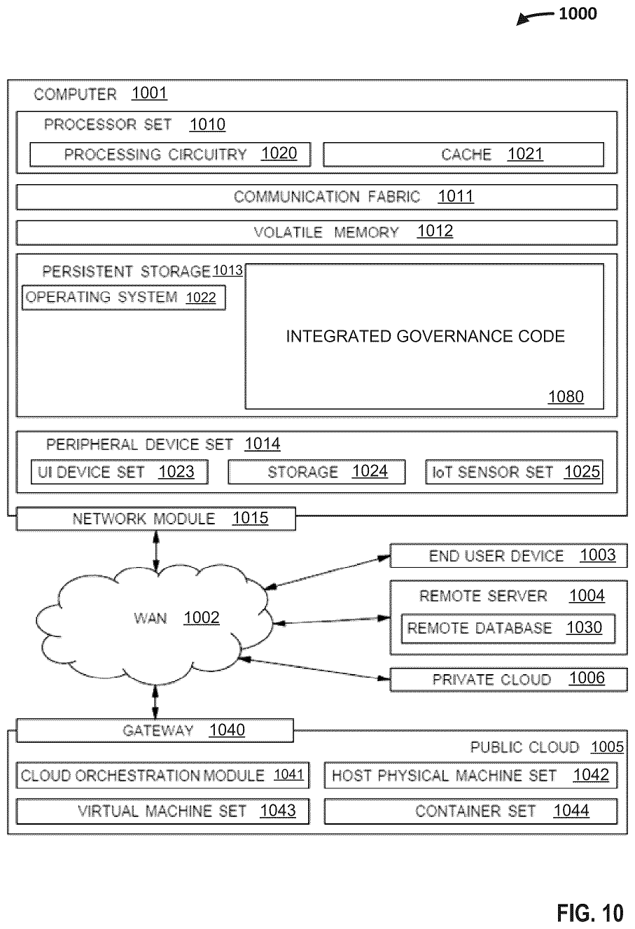

FIG. 10 and the following discussion are intended to provide a brief, general description of a suitable computing environment 1000 in which one or more embodiments described herein at FIGS. 1-9 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as translation of an original source code based on a configuration of a target system by the integrated governance code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1080, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method can be distributed among multiple computers and/or between multiple locations. On the other hand, in this presentation of computing environment 1000, detailed discussion is focused on a single computer, specifically computer 1001, to keep the presentation as simple as possible. Computer 1001 can be located in a cloud, even though it is not shown in a cloud in FIG. 10. On the other hand, computer 1001 is not required to be in a cloud except to any extent as can be affirmatively indicated.

PROCESSOR SET 1010 includes one, or more, computer processors of any type now known or to be developed in the future. Processing circuitry 1020 can be distributed over multiple packages, for example, multiple, coordinated integrated circuit chips. Processing circuitry 1020 can implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set can be located “off chip.” In some computing environments, processor set 1010 can be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods can be stored in block 1080 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory can be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 can be a read only memory (ROM), but typically at least a portion of the persistent storage allows writing of data, deletion of data and re-writing of data. Some familiar forms of persistent storage include magnetic disks and solid-state storage devices. Operating system 1022 can take several forms, such as various known proprietary operating systems or open-source Portable Operating System Interface type operating systems that employ a kernel. The code included in block 1080 typically includes at least some of the computer code involved in performing the inventive methods.

PERIPHERAL DEVICE SET 1014 includes the set of peripheral devices of computer 1001. Data communication connections between the peripheral devices and the other components of computer 1001 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 can include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 can be persistent and/or volatile. In some embodiments, storage 1024 can take the form of a quantum computing storage device for storing data in the form of qubits. In embodiments where computer 1001 is required to have a large amount of storage (for example, where computer 1001 locally stores and manages a large database) then this storage can be provided by peripheral storage devices designed for storing large amounts of data, such as a storage area network (SAN) that is shared by multiple, geographically distributed computers. IoT sensor set 1025 is made up of sensors that can be used in Internet of Things applications. For example, one sensor can be a thermometer and another sensor can be a motion detector.

NETWORK MODULE 1015 is the collection of computer software, hardware, and firmware that allows computer 1001 to communicate with other computers through WAN 1002. Network module 1015 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and can take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 can be a client device, such as thin client, heavy client, mainframe computer and/or desktop computer.

REMOTE SERVER 1004 is any computer system that serves at least some data and/or functionality to computer 1001. Remote server 1004 can be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data can be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs can be stored as images and can be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware and firmware allowing public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer-implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system comprising:
a memory that stores computer executable components; and
a processor that executes the computer executable components stored in the memory,
wherein the computer executable components comprise:
an integrated regulatory compliance component, comprising a machine learning model, wherein the machine learning model:
identifies new regulations and enterprise standards for an enterprise;
determines an impact to the enterprise based on the new regulations and the enterprise standards; and
updates baseline enterprise standards with one or more compliance actions based on the impact, wherein the baseline enterprise standards comprise an enterprise protected information baseline and an artificial intelligence (AI) baseline.

2. The system of claim 1, wherein the computer executable components further comprise a factsheet generation component, comprising a second machine learning model that:
tracks use of data comprising protected information, AI systems, AI models, and AI training datasets through one or more information tracking subcomponents;
compares the use of the data comprising the protected information, the AI systems, the AI models, and the AI training datasets to the updated baseline enterprise standards; and
generates, using the second machine learning model, model factsheets for the AI models based on the comparison, wherein the model factsheets comprise information used by the AI models, deployment histories of the AI models, and performance characteristics of the AI models.

3. The system of claim 2, wherein the factsheet generation component:
receives one or more manual inputs and automated intake of records related to a compliance framework, wherein the records comprise at least one of applications storing the protected information, the AI systems, the AI models, and the AI training datasets, and wherein the receiving the one or more manual inputs and automated intake of the records further comprises assessing an applicability of a record to one or more of the baseline enterprise standards.

4. The system of claim 2, wherein the one or more information tracking subcomponents comprise a protected information governance subcomponent that:
catalogs the use of the protected information within the enterprise;
determines when a new protected information record is called for;
in response to a determination that the new protected information record is called for, generates the new protected information record from an intake process; and
tracks protected information use within the enterprise.

5. The system of claim 2, wherein the one or more information tracking subcomponents comprise an insight subcomponent that:
generates one or more insights, wherein the one or more insights comprise identifications of use trends of the AI systems, the AI models, the AI training datasets, and the protected information.

6. The system of claim 2, wherein the one or more information tracking subcomponents further comprises an AI governance subcomponent that:
catalogs the AI systems and applications identified in the enterprise;
determines when a new AI record is called for;
in response to a determination that the new AI record is called for, generates the new AI record from an intake process; and
tracks one or more applications identified as comprising an AI component.

7. The system of claim 2, wherein the one or more information tracking subcomponents further comprises an initiative manager subcomponent that:
identifies one or more components of the enterprise impacted by one or more new regulations or one or more new enterprise standards; and
notifies the one or more identified components of the enterprise.

8. The system of claim 2, wherein the one or more information tracking subcomponents further comprises a data governance subcomponent that:
tracks design connections between one or more AI applications; and
tracks approval of one or more datasets used for training or input of the one or more AI applications.

9. The system of claim 2, wherein the one or more information tracking subcomponents further comprises an entity manager subcomponent that catalogs systems with the enterprise that store the protected information and the AI models.

10. A computer-implemented method comprising:
identifying, by a device operatively coupled to a processor, using a machine learning model, new regulations and enterprise standards for an enterprise;
determining, by the device, using the machine learning model, an impact to the enterprise based on the new regulations and the enterprise standards; and
updating, by the device, using the machine learning model, baseline enterprise standards with one or more compliance actions based on the impact, wherein the baseline enterprise standards comprise an enterprise baseline and an artificial intelligence (AI) baseline.

11. The computer-implemented method of claim 10, further comprising:
tracking, by the device, using a second machine learning model, use data comprising protected information, AI systems, AI models and AI training datasets;
comparing, by the device, using the second machine learning model, the use data comprising the protected information, the AI systems, the AI models, and the AI training datasets to the updated baseline enterprise standards; and
generating, by the device, using the second machine learning model, model factsheets for the AI models based on the comparison, wherein the model factsheets comprise information used by the AI models, deployment histories of the AI models, and performance characteristics of the AI models.

12. The computer-implemented method of claim 11, further comprising:
receiving, by the device, one or more manual inputs and automated intake of records related to a compliance framework, wherein the records comprise at least one of applications storing the protected information, the AI systems, the AI models, and the AI training datasets; and
assessing, by the device, an applicability of a record to one or more of the baseline enterprise standards.

13. The computer-implemented method of claim 11, further comprising:
cataloging, by the device, the use of the protected information within the enterprise;
determining, by the device, when a new protected information record is called for;
generating, by the device, in response to a determination that the new protected information record is called for, the new protected information record from an intake process; and
tracking, by the device, protected information use within the enterprise.

14. The computer-implemented method of claim 11, further comprising:
cataloging, by the device, the AI systems, the AI models, and AI applications identified in the enterprise;
determining, by the device, when a new AI record is called for;
generating, by the device, in response to a determination that the new AI record is called for, the new AI record from an intake process; and
tracking, by the device, one or more applications identified as comprising an AI component.

15. The computer-implemented method of claim 11, further comprising:
tracking, by the device, design connections between one or more AI applications; and
tracking, by the device, approval of one or more datasets used for training or input of the one or more AI applications.

16. A computer program product comprising a non-transitory computer-readable memory, having program instructions embodied therewith, the program instructions executable, by a processor, to cause the processor to:
identify, by the processor, using a machine learning model, new regulations and enterprise standards for an enterprise;
determine, by the processor, using the machine learning model, an impact to the enterprise based on the new regulations and the enterprise standards; and
update, by the processor, using the machine learning model, baseline enterprise standards with one or more compliance actions based on the impact, wherein the baseline enterprise standards comprise an enterprise baseline and an artificial intelligence (AI) baseline.

17. The computer program product of claim 16, wherein the program instructions are further executable, by the processor, to cause the processor to:
track, by the processor, using a second machine learning model, use data comprising protected information, AI systems, AI models and AI training datasets;
compare, by the processor, using the second machine learning model, the use data comprising the protected information, the AI systems, the AI models, and the AI training datasets to the updated baseline enterprise standards; and
generate, by the processor, using the second machine learning model, model factsheets for the AI models based on the comparison, wherein the model factsheets comprise information used by the AI models, deployment histories of the AI models, and performance characteristics of the AI models.

18. The computer program product of claim 17, wherein the program instructions are further executable, by the processor, to cause the processor to:
receive, by the processor, one or more manual inputs and automated intake of records related to a compliance framework, wherein the records comprise at least one of applications storing the protected information, the AI systems, the AI models, and the AI training datasets; and
assess, by the processor, an applicability of a record to one or more of the baseline enterprise standards.

19. The computer program product of claim 17, wherein the program instructions are further executable, by the processor, to cause the processor to:
catalog, by the processor, the use of the protected information within the enterprise;
determine, by the processor, when a new protected information record is called for;
generate, by the processor, in response to a determination that the new protected information record is called for, the new protected information record from an intake process; and
track, by the processor, protected information use within the enterprise.

20. The computer program product of claim 17, wherein the program instructions are further executable, by the processor, to cause the processor to:
catalog, by the processor, the AI systems, the AI models, and AI applications identified in the enterprise;
determine, by the processor, when a new AI record is called for;
generate, by the processor, in response to a determination that the new AI record is called for, the new AI record from an intake process; and
track, by the processor, one or more applications identified as comprising an AI component.
